(19) United States
(12) Patent Application Publication
(10) Pub. No.: US 2013/0262316 A1
(43) Pub. Date: Oct. 3, 2013

(54) Securely Selling and Purchasing of Goods through Social Network Sites Using a Secure Mobile Wallet System as a Mobile Commerce

(71) Applicant: John Hruska, Stuart, FL (US)

(72) Inventor: John Hruska, Stuart, FL (US)

(21) Appl. No.: 13/543,864

(22) Filed: Jul. 8, 2012

Related U.S. Application Data
(62) Division of application No. 13/436,549, filed on Mar. 30, 2012.

(51) Int. Cl. G06Q 20/36; G06Q 20/20; G06Q 20/40

(52) U.S. Cl. 705/67

(57) ABSTRACT

A secure and convenient product purchasing system and method are disclosed to allow for online sale and purchase of goods by means of a social network site using a mobile wallet system as an m-Commerce shopping cart checkout linked to a secure financial closed-loop proxy account. A proprietary graphical or barcode-represented on-line digital product code and details to be posted to one user's social network wall, so as to be either scanned or directly selected, then paid for using the secure financial closed-loop proxy account and a pre-registered personal handheld mobile device where all funds within the account remain in an “inactive” non-usable state until activated and allocated by another user through their mobile device, where both users are registered to the secure financial closed-loop proxy account.

### SUMMARY

With the advent of the mobile society people are becoming more comfortable with purchases made through their mobile devices. Both convenience and security should be at the center of this m-Commerce revolution that is taking place. Unlike the current on-line method of purchasing of goods which was an afterthought when it comes to secure payments; the ability to purchase items using your mobile device is real apparent and security and protection of personal financial information should be at its core.

The patent embodiment below describes a secure and convenient process of being able to sell and purchase goods through a social network site using a Mobile Wallet system as an m-Commerce shopping cart checkout. Providing the protection of never having to provide or disclose any personal financial information ever again after registering and setting up the Mobile Wallet account.

### BRIEF DESCRIPTION OF THE DRAWINGS

FIG. 1 demonstrates the procedure for the Seller to sell their product on their social network by means of and through a registered mobile device utilizing a Mobile Wallet app.

FIG. 2 demonstrates the procedure for the Seller as part of a Mobile Wallet system to sell their product on their social network by means of a PC and computer-based application for members of the Mobile Wallet system to purchase.

FIG. 3a demonstrates the procedure for a registered Mobile Wallet user (buyer) to purchase the item listed and displayed by another Mobile Wallet user (seller) on their social network by scanning a QR-Code.

FIG. 3b shows a procedure for a registered Mobile Wallet buyer to purchase the item displayed on their social network directly by mobile device and Mobile Wallet application.

FIG. 4 shows the Mobile Wallet system backend transactional process, delivery fulfillment and account reconciliation of the purchase made via the social network site.

### DETAILED DESCRIPTION

A user signs up to a Mobile Wallet system by downloading the Mobile Wallet application from a smart phone store (iPhone or Android) and creates an account by specifying all appropriate information: name, address, mobile number, e-mail address, their social network account names and linking permissions (e.g Facebook, Twitter and Pinterest names) and setting up a PIN and Password; then registering the smart phone by the backend sending the smart phone handset mobile unit a registration code through text messaging which is required to be entered into the application fields to complete the account set up and registration process. Once an account is created, the user may fund and unload the account by linking a personal or business bank account to their Mobile Wallet account or linking credit cards to the Mobile Wallet account. The bank account and credit card details are then verified through a payment gateway third party system. Once the financial information is verified the user will be able to load and unload funds to their Mobile Wallet account. A secure proxy account closed loop is completed where transactions can take place amongst its members for the purpose of selling and buying goods which are advertised on their personal social network sites.

### Selling Goods on Social Networks Using a Mobile Wallet System

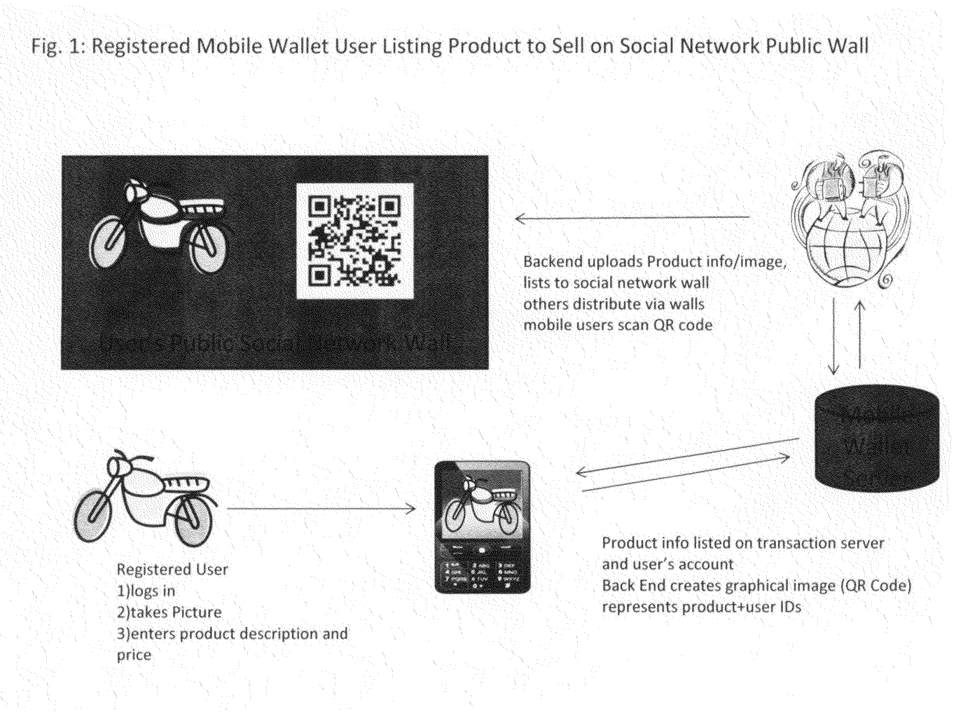

The Mobile Wallet system has a selling feature which allows the user to be able to sell products whenever they prefer. The user needs to sign into their application using their password and PIN. Once the user is authenticated they are able to select the selling product feature. After agreeing to the terms of use from the selling feature of the Mobile Wallet system, as shown in FIG. 1, the user will be able to upload and sell goods and products by taking a picture, writing a description, placing a quantity and a price for the product to be sold. The user is given the option of which social network to distribute and display their product to be sold. The product information is collected and stored on the Mobile Wallet backend servers. The Mobile Wallet backend creates a unique product identifier identifying the User and the product information and is used for back end cataloging and tracking A binary graphical image (such as a barcode or QR Code) is created by the backend using the product identifier information. As a social network friend of the user the Mobile Wallet backend system uploads and displays the user's product along with the corresponding QR code (graphical image) onto the user's publicly disseminated social network wall for other members of the Mobile Wallet system to purchase. Both the product image and the binary graphical image (Barcode) is uploaded to the user's social network public display walls, to their friends' public display walls and to the Mobile Wallet's public displayed walls (Facebook, Twitter, Pinterest, Fab.com and others). This information will be listed in the history of the seller's Mobile Wallet account.

Selling from the PC without Using the Mobile Device

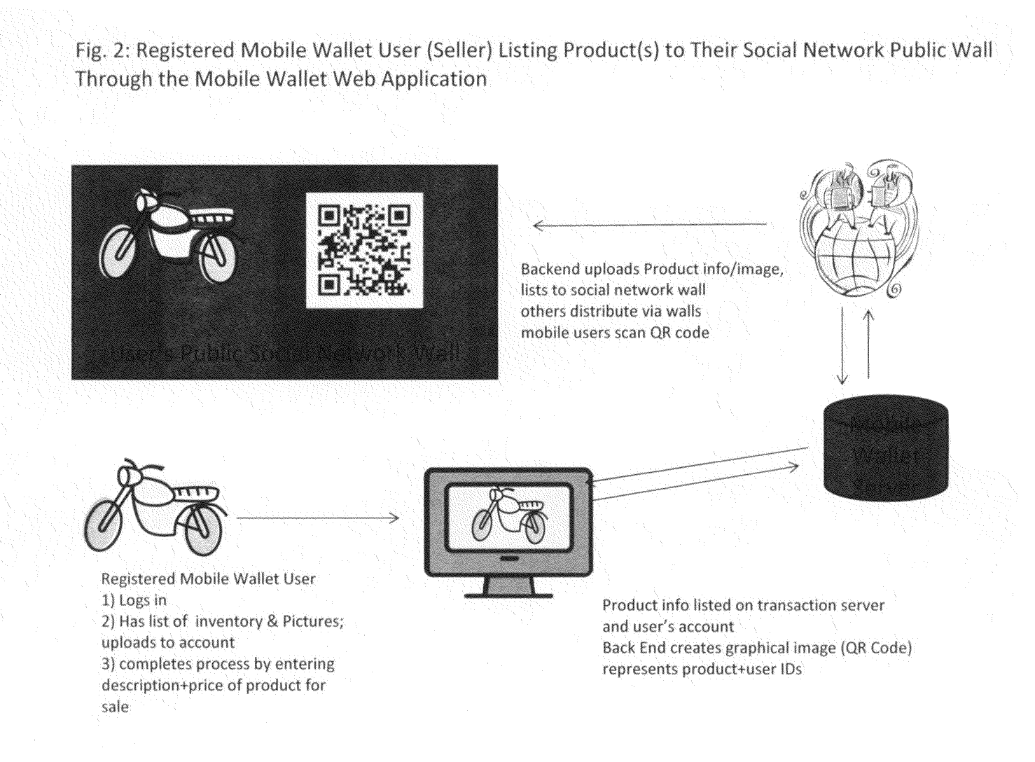

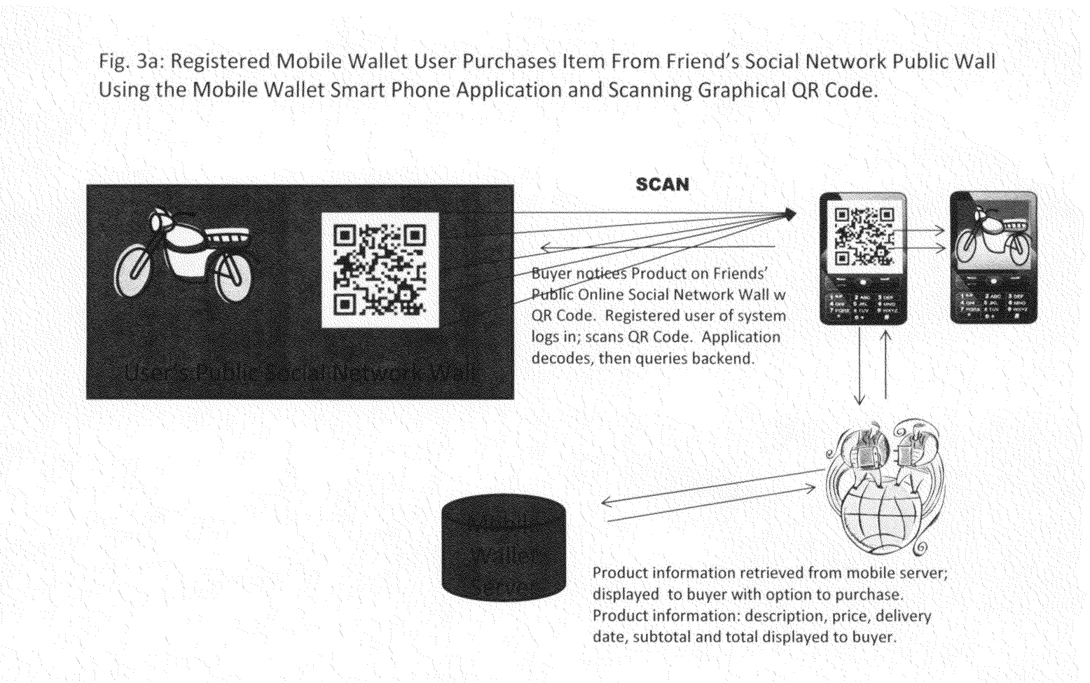

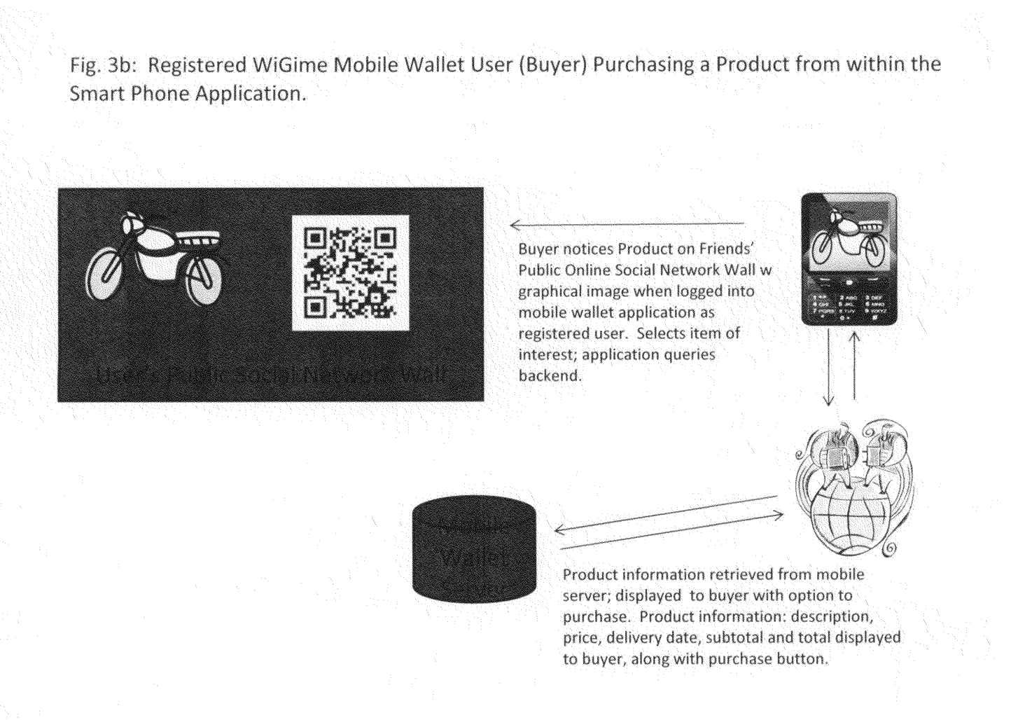

FIG. 2 shows an alternative method to listing, viewing, selling and buying, wherein the product for sale can be uploaded from a personal computer through the Mobile Wallet web account on a social network website, without scanning the QR code. While using the Mobile Wallet application in order to make the purchase, a Mobile Wallet user can log into their Mobile Wallet application and may view the listed products being sold on existing social network sites, as shown in FIG. 3b. By selecting the item displayed on the user's social network public wall while viewing it from within the Mobile Wallet application, in a similar fashion as described above, the Mobile Wallet backend provides a description/confirmation page for the user to purchase the product. The difference is that the user need not scan a QR code to make the purchase from within the application but just select the item from within the mobile application. All other elements remain the same as described in the previous sections above.

### Buying Goods on Social Networks Using a Mobile Wallet System

The registered Mobile Wallet user wishing to purchase a product displayed and listed on a social network signs into their smart phone Mobile Wallet application. Once authenticated, they will select the Scan and Buy™ feature of the Mobile Wallet system. After agreeing to the terms the user (buyer), by using the smart phone's camera, as shown in FIG. 3a, they will scan the binary graphic image (barcode) displayed on the social network site alongside the product image. The application will decode the barcode image and requested information will be sent to the Mobile Wallet application from the backend over a secure SSL data network connection. The product identifier information will be used to look up the seller's information, the product information and product image and are sent through a data network connection which will be displayed on potential buyer's smartphone display with a “Purchase” and “Decline” buttons.

By selecting the Purchase button on the smart phone Mobile Wallet application the user requests to buy the displayed product that was scanned. A detailed confirmation page is presented to the buyer with the product description, the product amount, taxes and delivery charges, address to be delivered (which can be edited) and with a total amount. The buyer at this point has three options: 1) To Cancel the Order, 2) To Keep Shopping, 3) To Purchase the Product. The cancel option will cancel the order and the user will return to the main page of the Mobile Wallet application. The keep shopping option will keep the selected item in a queue on the Mobile Wallet backend. If during the session more items are scanned and confirmed to be purchased the final m-commerce shopping cart page of the Mobile Wallet system will be presented to the buyer at the end of the m-commerce session, providing a list of items that are being purchased with an itemized list of: product information, pricing and seller's information, product amounts, subtotals and totals including taxes and delivery charges and estimated delivery date. Once the user (buyer) selects the “Purchase” option, an editable delivery address is also displayed and needs to be confirmed. The Mobile Wallet backend will confirm the total amount of purchase and check the buyer's Mobile Wallet account to see if sufficient funds are present in their available balance. If not, the available balance will be shown and the itemized m-commerce shopping cart presented so items can be eliminated to the point where the total amount will be less than total purchase price.

Note: Alternatively a buyer has the option to directly purchase an item from a social network wall display while being viewed from within the Mobile Wallet application installed on their mobile device and would thus be able to omit the scan step of the QR code presented on the seller's wall to make a purchase. A user can directly select the link to the item listing from the social network to the item webpage, then consummate the purchase in the steps illustrated above. This scenario is illustrated in FIG. 3b, showing a registered WiGime™ Mobile Wallet user (buyer) purchasing a product from a social network public wall from within and through the Mobile Wallet smart phone application.

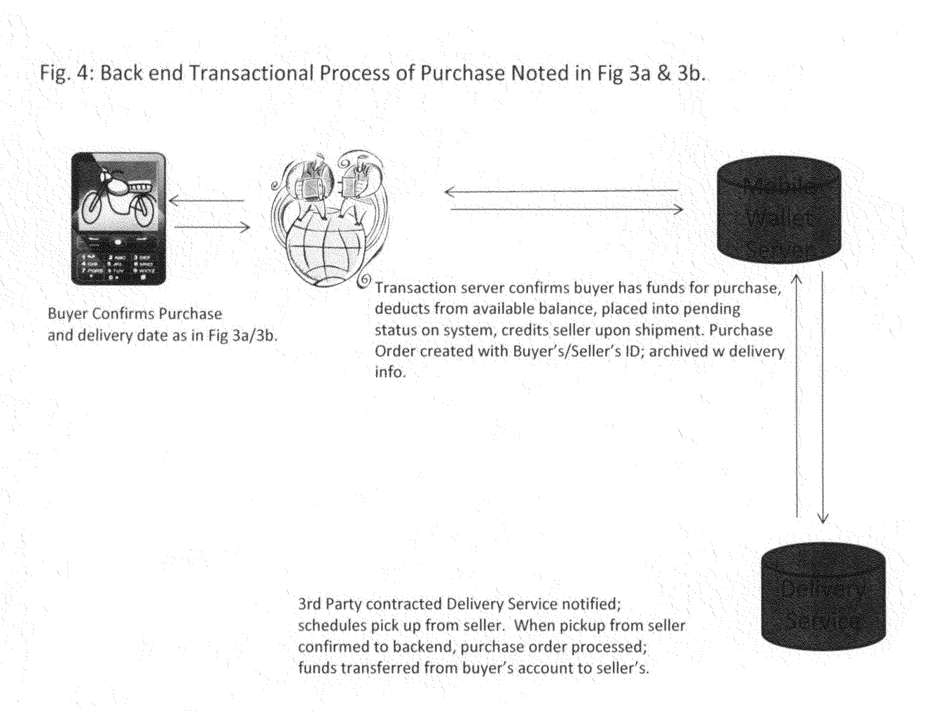

Once a purchase is made as shown in FIG. 4, the backend confirms sufficient funds are present in the buyer's mobile money account, and funds are deducted from the account, adjusting their available balance. The backend creates an order number for the specific transaction and an e-mail is sent to the seller confirming a transaction has completed with the listed item and total amount. The e-mail contains a link for the seller to provide a pickup address where a third party shipping service may pick up the product to be shipped. Using a tracking system, delivery of packages can be tracked. Once the shipping service confirms the item has been delivered, the Mobile Wallet backend system will release the funds to the seller's Mobile Wallet account and their available balance adjusted. The order process will show as completed in both the seller's and buyer's Mobile Wallet itemized history along with the details including each other's e-mails.

The overall patent above describes the ability to securely sell and buy goods and products on a social network site through a Mobile Wallet system; creating a secure m-commerce shopping cart using a secure Mobile Wallet consumer-merchant proxy account for those Mobile Wallet members who have social network accounts. However, the implementations described should not be viewed as the exclusive embodiments of the system, and may include all possible embodiments realizing the system and method of the disclosure.

I claim:

1. An online mobile social-network-based secure m-commerce online mobile wallet system on a computer based social network for secure sale of a product by a first user of the system to a second user of the system by means of the user's pre-registered personal mobile device, comprising:
a secure financial proxy account such as an online mobile wallet, established for the purpose of holding all users' unused dormant funds pooled together as part of the system, up until the second user activates and allocates their funds for buying a product from the first user by means of their registered personal mobile device and mobile application;
a registration protocol for the personal mobile device on the system;
an authentication application which provides a mechanism for the users to log in and be authenticated onto the system;
a point of sale mobile application installed on each personal mobile device, which utilizes a camera on the personal mobile device to take a picture of a product and accept a quantity and a price for the product to be sold;
a transactional and authentication server which stores and authenticates data sent from the users' personal mobile devices and their mobile applications over a telecommunications network;
a product listing generating application on the transactional and authentication server which expresses the product information and price along with information about the first user listing and selling the product in the form of a graphical image, and then places the graphical image upon a profile page on the of the first user on the social network;
a point of purchase mobile application installed on the personal mobile device of the second user, which reads and decodes a graphical image placed upon a page of the first user on the social network to identify the information and price for the product as well as information about the first user listing and selling the product on the social network;
an activation protocol for identifying the second user's registered mobile device, using a unique authentication identification number specific to that personal mobile device and the mobile application installed on that device, the second user to make the account and funds active to purchase a specific product from the specific first user listing and selling the specific product;
a proprietary application resident on the transactional and authentication server which creates a unique user, device and product-specific, time-sensitive, single-use encrypted digital transactional alphanumeric token which is specific to the user's personal mobile device, its location, both users' personal identification information, the specific product being sold by the first user to the second user, as well as its price and information.

2. The system of claim 1, further comprising the step of:
a personal computer of the first user for them to login to their social network and the online mobile social-network-based secure m-commerce online mobile wallet system on; and
an instance of the social network and of the system running on the first user's personal computer.

3. The system of claim 1, further comprising the step of:
The system of claim 1, further comprising the step of:
a personal computer of the second user for them to login to their social network and the online mobile social-network-based secure m-commerce online mobile wallet system on;
an instance of the social network and of the system running on the first user's personal computer; and
a scanning device and a scanner application on the second user's mobile device for them to scan the graphical image such as a barcode representing the product for the sale displayed on the system running on the second user's personal computer.

4. The system of claim 1, incorporating logical rules to set a notification for the users if the product price exceeds the amount of funds available in the proxy account so that the second user may replenish funds.

5. A method for secure sale of a product by a first user of an online social-network-based secure m-commerce online mobile wallet system to a second user of the online social-network-based secure m-commerce online mobile wallet system by means of both users' pre-registered personal mobile devices, comprising the steps of:
establishing a secure financial proxy account such as an online mobile wallet, for the purpose of holding unused dormant funds of all users on the online social-network, until such time that the second user activates and allocates their unused dormant funds by means of their registered personal mobile device and a mobile application installed on the personal mobile device for purchase of the product from the first user and subsequent transfer of those funds to the first user;
linking the secure financial proxy account to a transactional and authentication server, upon which resides an application to effectuate the secure sale of the product by the first user to the second user;
creating an online product advertisement, information and price, by means of the first user taking a picture of the product with a camera on their personal mobile device and by entering text on a keyboard on the personal mobile device.
generating a graphical image such as a barcode to represent the product for the sale by means of an appropriate mobile application on the personal mobile device;
validating each user by allowing them to log in to their mobile application installed on their personal mobile device, then comparing to information for that user stored on the transactional and authentication server and also verifying against a profile for that user which exists on the online social network;
passing user information retrieved at the time of validating to the transactional and authentication server;
placing the product advertisement, information and price represented in the form of the graphical image such as a barcode, as well as a link to the online product advertisement on a profile page for the first user on an online social network of which both first and second users are members;
allowing the second user to select the graphical image such as a barcode on the first user's profile page on the online social network and then decoding the product advertisement, information and price by means of the mobile application installed on the second user's personal mobile device in order to identify and flag the first user and product on sale for the system;
generating a unique user device and product specific, time-sensitive, single-use encrypted digital transactional alphanumeric token which is specific to the personal mobile device, its location, the user's personal identification information, the specific product being sold by the user, as well as its price and information, along with the second user to whom the product is being sold by the transactional and authentication server using the unique identifier of the specific personal mobile device, the unique identifier of the mobile application installed on the personal mobile device, the first user's personal identification information, the first user's specific product advertisement, information and price, and the second user's personal identification information, for the purpose of making payment for the particular product to the first user;
verifying by the first user of the second user's information, the product advertisement, information and price, and the unique user, device and product specific, time-sensitive, single-use encrypted digital transactional alphanumeric token;
redeeming by the first user of the unique user and device specific, time-sensitive, single-use encrypted digital transactional alphanumeric token, upon verifying the token and the second user's information, in order to transfer the second user's activated funds to the account of the first user;
shipping of the product by the first user to an address on file for the second user in order to consummate the purchase of the product.

6. The method of claim 5, further comprising the step of:
the first user logging in to their social network and the online mobile social-network-based secure m-commerce online mobile wallet system on a personal computer; and
wherein the steps of placing the product advertisement, information and price on the profile page and of creating an online product advertisement, information and price, and generating the graphical image such as a barcode to represent the product for the sale are all achieved by means of the system running on the first user's personal computer.

7. The method of claim 5, further comprising the step of:
the second user logging in to their social network and the online mobile social-network-based secure m-commerce online mobile wallet system on a personal computer; and
scanning the graphical image such as a barcode representing the product for the sale displayed on the system running on the second user's personal computer by means of their mobile device which takes the second user to the online product advertisement, allowing the second user to then consummate the purchase of the product.

8. The method of claim 5, further comprising the steps of:
logically checking if the product price exceeds the amount of funds available in the proxy account; and
generating a notification for the users if the product price exceeds the amount of funds available in the proxy account so that the second user may replenish funds.
